(19) United States
(12) Patent Application Publication
(10) Pub. No.: US 2026/0078738 A1
(43) Pub. Date: Mar. 19, 2026

(54) WIND TURBINE BLADE LIFTING DEVICE BASED ON OFFSHORE WIND TURBINE UNIT

(71) Applicant: CTG Jiangsu Energy Investment Co., Ltd., Nanjing City (CN)

(72) Inventors: Yijin TANG, Nanjing City (CN); Dong CAI, Nanjing City (CN); Yu LIU, Nanjing City (CN); Hao JIANG, Nanjing City (CN); Jianjun ZHU, Nanjing City (CN); Xiaohui JIA, Nanjing City (CN); Xingxing WANG, Nanjing City (CN); Zhaoxia PENG, Nanjing City (CN); Xingguo LI, Nanjing City (CN); Yanliang GU, Nanjing City (CN); Jiachen LI, Nanjing City (CN); Houzhi YU, Nanjing City (CN)

(21) Appl. No.: 18/926,145

(22) Filed: Oct. 24, 2024

(30) Foreign Application Priority Data
Sep. 18, 2024 (CN) 202411303943.1

(51) Int. Cl. F03D 13/10

(52) U.S. Cl. CPC F03D 13/139; F03D 13/126; F05B 2230/61

(57) ABSTRACT

The present application provide a wind turbine blade lifting device based on an offshore wind turbine unit, including: a clamping assembly and an adjusting assembly, where the clamping assembly includes a clamping box and a plurality of clamping base members, the clamping box is internally provided with a fixing plate, and the plurality of clamping base members are independently provided on both sides of the clamping box; the clamping base members penetrate through a sidewall of the clamping box and extend into the clamping box and are detachably connected to the adjusting assembly provided in the clamping box; the adjusting assembly includes a conveying member, a hydraulic barrel, and a fixing barrel, the conveying member is provided at bottom of the fixing plate, both sides of the conveying member are detachably connected to the plurality of clamping base members, respectively.

### CROSS-REFERENCE TO RELATED APPLICATIONS

This application claims priority to Chinese Patent Application No. 202411303943.1, filed on Sep. 18, 2024, which is hereby incorporated by reference in its entirety.

### TECHNICAL FIELD

The present application relates to the technical field of wind turbine installation and, in particular, to a wind turbine blade lifting device based on an offshore wind turbine unit.

### BACKGROUND

With the continuous growth of global demand for renewable energy, offshore wind power, as a clean, efficient, and sustainable energy form, is increasingly emphasized in its development and utilization. During construction of an offshore wind turbine system, the efficiency and safety of lifting a wind turbine blade to a designated position for installation directly impact the progress and cost of an entire project.

Due to complex and changeable offshore environment, as well as the complexity of the lifting operation process, an existing wind turbine blade lifting device has issues such as severe swaying during lifting, low accuracy of docking, and high risk of safety.

### SUMMARY

Embodiments of the present application provide a wind turbine blade lifting device based on an offshore wind turbine unit to solve technical problems of blade lifting device in the art, such as low accuracy of docking, easy shaking during lifting, and prone to safety accident.

An embodiment of the present application provides a wind turbine blade lifting device based on an offshore wind turbine unit, including: a clamping assembly and an adjusting assembly;
where the clamping assembly includes a clamping box and a plurality of clamping base members, the clamping box is internally provided with a fixing plate, and the plurality of clamping base members are independently provided on both sides of the clamping box; the clamping base members penetrate through a sidewall of the clamping box and extend into the clamping box, and are detachably connected to the adjusting assembly provided in the clamping box;
where the clamping base members are configured to clamp a wind turbine blade, and the adjusting assembly is capable of controlling free movements of the plurality of clamping base members on the clamping box in a same direction or in opposite directions;
where the adjusting assembly includes a conveying member, a hydraulic barrel and a fixing barrel, the conveying member is provided at bottom of the fixing plate, both sides of the conveying member are detachably connected to the plurality of clamping base members; and
where the fixing barrel penetrates through top of the fixing plate and extends to bottom of the conveying member, the hydraulic barrel is socketed into the fixing barrel, the fixing barrel is in communication with the conveying member, and free movements of the clamping base members are controlled hydraulically.

In a feasible implementation, the clamping base members include a first clamping arm and a second clamping arm of identical structure, as well as a first clamping member and a second clamping member of identical structure;
where a T-slot is provided on a sidewall of the clamping box located below the fixing plate, and an end of the first clamping arm penetrates through the T-slot and is movably connected to and in communication with the conveying member; and the first clamping member is fixedly provided at bottom of the other end of the first clamping arm; and
where the first clamping member has a clamping slot parallel to the clamping box, and the clamping slot is configured to clamp the wind turbine blade.

In a feasible implementation, a plurality of telescopic rods, and a plurality of hydraulic pipes are provided at each side of the conveying member;
one ends of the plurality of telescopic rods are independently fixedly connected to side edges of two sides of the conveying member, respectively, and the other ends of the plurality of telescopic rods are socketed into the first clamping arm; and
the plurality of hydraulic pipes communicate the conveying member with the first clamping arm, and the hydraulic pipes is in communication with the fixing barrel.

In a feasible implementation, a holding space is provided in the fixing barrel, and a plurality of connecting pipes are connected to an outer sidewall of the fixing barrel, and the connecting pipes are in communication with the holding space; and
the connecting pipes are in communication with the conveying member, and the hydraulic pipes; the hydraulic barrel is socketed into the holding space, and the hydraulic barrel moves up and down freely in the holding space.

In a feasible implementation, a blocking base member is further provided in the holding space, and the blocking base member is fixedly connected or detachably connected to an inner sidewall of the holding space; and
a hydraulic orifice is provided at bottom of the hydraulic barrel, and when the hydraulic barrel is socketed into the holding space, the blocking base member is inserted into the hydraulic orifice.

In a feasible implementation, a plurality of slide grooves are provided on the inner sidewall of the holding space, and a plurality of slide blocks are correspondingly provided on an outer sidewall of the hydraulic barrel; and
when the hydraulic barrel is rotated or moved in the holding space, the slide blocks slide freely in the slide grooves; and the slide grooves form a slope along the inner sidewall of the holding space so that the slide blocks are temporarily stuck in the slide grooves when the hydraulic barrel is moved to bottom of the holding space.

In a feasible implementation, a plurality of elastic members are provided at the bottom of the hydraulic barrel;
a plurality of through-holes are further provided on the hydraulic barrel, the through-holes are perpendicular to and in communication with the hydraulic orifice; and
a pulling member is further provided at top of the hydraulic barrel, the pulling member is configured to enable the hydraulic barrel to slide up and down freely in the holding space of the fixing barrel;
where a height of the hydraulic barrel is greater than a depth of the holding space, and a diameter of the hydraulic barrel is matched with a diameter of the holding space.

In a feasible implementation, the blocking base member includes a plurality of blocking plates and a blocking plate frame;
the blocking plate frame is connected to an inner wall of the holding space, and a plurality of circular plates are provided at top of the blocking plate frame, and sizes of the circular plates are matched with the through-holes; a circular convex plate is provided at bottom of the blocking plate frame, and a size of the circular convex plate is matched with the hydraulic orifice;
when the hydraulic barrel is moved upwardly in the holding space, the blocking plates are enabled to block the through-holes, to adjust the first clamping arm and the second clamping arm to move in opposite directions; and
when the hydraulic barrel is moved downwardly in the holding space, the circular convex plate is enabled to block the hydraulic orifice, to adjust the first clamping arm and the second clamping arm to move in a same direction.

In a feasible implementation, top of the first clamping arm is fixedly provided with a sliding member, and correspondingly, the fixing plate is provided with a bar slot; and
the sliding member is stuck in the bar slot, and the sliding member freely slides in the bar slot when the first clamping arm is freely moved; a maximum or minimum movement distance of the first clamping arm is controlled by the sliding member and the bar slot.

In a feasible implementation, the wind turbine blade lifting device further includes a control platform, the control platform is connected to outside of the clamping box and is in communication with the adjusting assembly; the clamping base members are controlled to move freely by inputting a hydraulic fluid into the adjusting assembly via the control platform;
where the control platform includes a connecting arm and an transporting pipe, the connecting arm is connected to the clamping box, and the transporting pipe penetrates through the clamping box and is in communication with the adjusting assembly.
   Embodiments of the present application provide a wind turbine blade lifting device based on an offshore wind turbine unit, including: a clamping assembly and an adjusting assembly, where the clamping assembly includes a clamping box and a plurality of clamping base members, the clamping box is provided with a fixing plate, and the plurality of clamping base members are independently provided on both sides of the clamping box; the clamping base members penetrate through a sidewall of the clamping box and extend into the clamping box and are detachably connected to the adjusting assembly provided in the clamping box; where the clamping base members are used to clamp a wind turbine blade, and the adjusting assembly is capable of controlling free movements of the plurality of clamping base members on the clamping box in a same or in opposite directions; the adjusting assembly includes a conveying member, a hydraulic barrel, and a fixing barrel, the conveying member is provided at bottom of the fixing plate, both sides of the conveying member are detachably connected to the plurality of clamping base members; the fixing barrel penetrates through top of the fixing plate and extends to bottom of the conveying member, the hydraulic barrel is socketed into the fixing barrel, the fixing barrel is in communication with the conveying member, and free movements of the clamping base members are controlled hydraulically. When the wind turbine blade is lifted from the ground, and is moved to a specified position in vertical and horizontal directions, the wind turbine blade lifting device provided by the present application can effectively avoid swaying, and at the same time, and can also effectively control an accuracy of docking, so as to improve the efficiency and safety performance of the installation of the wind turbine blade.

### BRIEF DESCRIPTION OF DRAWINGS

The accompanying drawings herein, which are incorporated into and form a part of the present specification, illustrate embodiments consistent with the present application, and are used in conjunction with the specification to explain the principles of the present application.

FIG. 1 is a top-viewed structure schematic diagram of a wind turbine blade lifting device based on an offshore wind turbine unit according to an embodiment of the present application.

FIG. 2 is a structure schematic diagram of a wind turbine blade lifting device based on an offshore wind turbine unit according to an embodiment of the present application.

FIG. 3 is a front-viewed structure schematic diagram of a wind turbine blade lifting device based on an offshore wind turbine unit according to an embodiment of the present application.

FIG. 4 is one structure schematic diagram of a clamping assembly and an adjustment assembly of a wind turbine blade lifting device based on an offshore wind turbine unit according to an embodiment of the present application.

FIG. 5 is another structure schematic diagram of a clamping assembly and an adjustment assembly of a wind turbine blade lifting device based on an offshore wind turbine unit according to an embodiment of the present application.

FIG. 6 is a structure schematic diagram of an adjustment assembly of a wind turbine blade lifting device based on an offshore wind turbine unit according to an embodiment of the present application.

FIG. 7 is one structure schematic diagram of a hydraulic barrel of a wind turbine blade lifting device based on an offshore wind turbine unit according to an embodiment of the present application.

FIG. 8 is another structure schematic diagram of a hydraulic barrel of a wind turbine blade lifting device based on an offshore wind turbine unit according to an embodiment of the present application.

FIG. 9 is a schematic diagram of a wind turbine blade lifting device based on an offshore wind turbine unit according to an embodiment of the present application when lifting a blade.

Illustration of reference numbers:
100—control platform;
110—connecting arm;
120—transporting pipe;
200—clamping assembly;
210—clamping box;
211—snap-fit slot;
212—bar slot;
213—T-slot;
214—fixing plate;
220—first clamping arm;
221—first clamping member;
230—second clamping arm;
231—second clamping member;
240—telescopic rod;
250—hydraulic pipe;
260—sliding member;
300—adjusting assembly;
310—conveying member;
320—hydraulic barrel;
321—pulling member;
322—through-hole;
323—slide block;
324—elastic member;
330—fixing barrel;
331—blocking base member;
3311—blocking plate frame;
332—blocking plate;
3321—circular plate;
3322—circular convex plate;
333—slide groove;
334—connecting pipe;
10—wind turbine blade;
11—crane base;
12—steel cable.

The definite embodiments of the present application have been illustrated by the accompanying drawings above, which will be described in more detail in the following. These accompanying drawings and textual descriptions are not intended to limit in any way the scope of the concept of the present application, but rather to illustrate the concept of the present application for those skilled in the art through specific embodiments.

### DESCRIPTION OF EMBODIMENTS

Exemplary embodiments will be described here in detail, examples of which are represented in the accompanying drawings. When the following description relates to the accompanying drawings, the same numbers in the different accompanying drawings indicate the same or similar elements unless otherwise indicated. The implementations described in the following exemplary embodiments do not represent all implementations consistent with the present application. Rather, they are only examples of apparatuses and methods consistent with some aspects of the present application as detailed in the appended claims.

In the description of the present application, it is to be understood that terms such as “counterclockwise”, “clockwise”, “longitudinal”, “lateral”, “up”, “down”, “front”, “back”, “left”, “right”, “vertical”, “horizontal”, “top”, “bottom”, “inner”, “outer” indicate orientations or positional relationships based on those shown in the accompanying drawings only for purpose of describing the present application. These terms are not intended to indicate or imply that a device or an element referred to must have particular orientations, or be constructed and operated in particular orientations. Consequently, they should not be construed as limitations of the application.

Wind power generation is to convert wind energy into electrical energy. Generally, as a length and a weight of a wind turbine blade of wind turbine increase, power generation capacity also increases accordingly. Installation of a wind turbine unit typically involves lifting the wind turbine blade to a desired height and position, and then securely mounting it onto a wind turbine tower.

Due to complex and changeable offshore environment, during a process of lifting the blade, a lifting device hoists the blade from position A and moves it to position B for installation, and it is prone to significant swaying during this process, and the blade is not easily docked with an installation interface, and safety accidents such as blade dropping may easily occur.

Embodiments of the present application provide a wind turbine blade lifting device based on an offshore wind turbine unit, which aims to address technical problems of the blade lifting device in prior art, such as low accuracy of docking, prone to swaying during lifting, and susceptible to a safety accident, etc. The present application controls distances between a plurality of clamping base members of a clamping assembly by an adjusting assembly, allowing the clamping base members to clamp wind turbine blades of different lengths, and the adjusting assembly then, after reaching a specified height, controls movements of the plurality of clamping base members in a same direction to a specified position, thereby avoiding safety accidents created by swaying.

The technical solutions of the present application and how the technical solutions of the present application solve the above technical problems are described in detail in the following specific embodiments. The following specific embodiments may be combined with each other, and the same or similar concepts or processes may not be repeated in some embodiments. The embodiments of the present application will be described below in conjunction with the accompanying drawings.

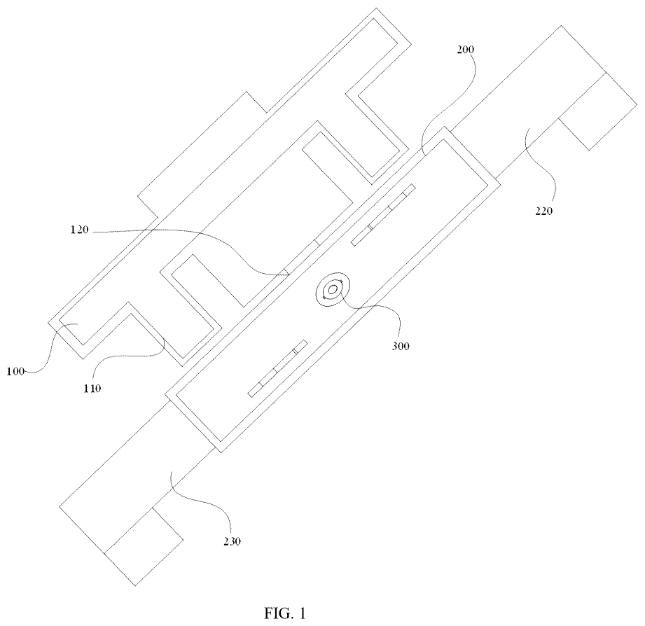

FIG. 1 is a top-viewed structure schematic diagram of a wind turbine blade lifting device based on an offshore wind turbine unit according to an embodiment of the present application. As shown in FIG. 1, the wind turbine blade lifting device includes a clamping assembly 200 and an adjusting assembly 300; where the clamping assembly 200 includes a clamping box 210 and a plurality of clamping base members, the clamping box 210 is provided with a fixing plate 214 therein, and the plurality of clamping base members are independently provided on both sides of the clamping box 210; the clamping base members penetrate through a sidewall of the clamping box 210 and extend into the clamping box 210, and are detachably connected to the adjusting assembly 300 provided in the clamping box 210; where the clamping base members are used to clamp a wind turbine blade, and the adjusting assembly 300 is capable of controlling free movements of the plurality of clamping base members on the clamping box 210 in a same direction or in opposite directions.

The clamping assembly 200 is used to clamp the wind turbine blade, allowing the lifting device to lift the wind turbine blade to a target height and position for installation. The clamping assembly 200 can clamp wind turbine blades of different lengths. For example, a plurality of differently spaced clamps can be provided on the clamping assembly 200, and a spacing between every two clamps can be equal or unequal to correspond with the wind turbine blades of different lengths. It is also possible to movably provide two clamps on the clamping assembly 200, and a spacing between the two clamps can be adjusted freely according to the wind turbine blades of different lengths.

A clamping opening of a clamp provided on the clamping assembly 200 for clamping the wind turbine blade may be movable or fixed. For example, the clamping opening can be movable, so that a size of the clamping opening can be adjusted when clamping wind turbine blades of different thicknesses. The clamping opening can also be fixed, and in an embodiment, the clamping opening can be provided in a shape of “□”, and a spacing and an opening between upper and lower clamp arms of the clamp can be fixed, and due to a fact that the wind turbine blade has a certain width, the wind turbine blade can be clamped in the clamping opening. Of course, a specific structure of the clamp provided on the clamping assembly 200 for clamping the wind turbine blade includes, but is not limited to the above mentioned examples, and any structure that can clamp the wind turbine blade horizontally is included in the inventive concept of the present application.

The plurality of clamping base members on the clamping assembly 200 are movably provided on both sides of clamping box 210. The above clamps can be connected to the clamping base members through welding, bonding, etc., or detachably connected to the clamping base members through pin, snap-fit, etc. The clamps can move freely together with the clamping base members. A fixing plate 214 is provided on the clamping box 210, and the fixing plate 214 is provided on top of the clamping base members.

The adjusting assembly 300 can control and adjust the clamping assembly 200 to move freely horizontally by means of electrical control, hydraulic control, electromagnetic control, or elastic control, etc., and can also control and adjust the plurality of clamps in the clamping assembly 200 to move horizontally in a same direction or in different directions. For example, when on the ground, to match with the wind turbine blades of different lengths, the adjusting assembly 300 controls the plurality of clamps on the clamping assembly 200 to move in an opposite direction, so as to clamp a wind turbine blade and to lift the lifting device and the wind turbine blade to a specified height using a steel cable on the lifting device. During a process of horizontally moving the wind turbine blade to a specified position, when the lifting device and the wind turbine blade horizontally move using a steel cable, a large sway will be generated on the sea surface, which is prone to a safety accident such as falling during lifting. Therefore, in the present embodiment, use of the adjusting assembly 300 to control the plurality of clamps on the clamping assembly 200 to move to the specified position in the same direction can avoid swaying well.

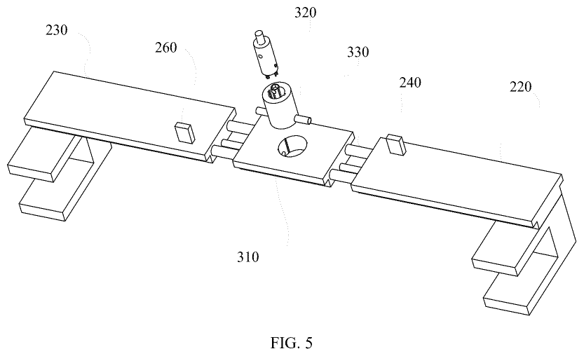

As shown in FIG. 5, the adjusting assembly 300 includes a conveying member 310, a hydraulic barrel 320, and a fixing barrel 330, the conveying member 310 is provided at bottom of the fixing plate 214, both sides of the conveying member 310 are detachably connected to the plurality of clamping base members, respectively; the fixing barrel 330 penetrates through top of the fixing plate 214 and extends to bottom of the conveying member 310, the hydraulic barrel 320 is socketed into the fixing barrel 330, the fixing barrel 330 is in communication with the conveying member 310, to control hydraulically free movements of the clamping base members.

The conveying member 310 is provided below the fixing plate 214 and is connected to the plurality of clamping base members to control the free movements of the clamping base members in a horizontal direction. One, two or more clamping base members may be connected to the conveying member 310 by welding, bonding, etc., or be detachably connected to the conveying member 310 by snap-fit, pin, etc. The clamping base member clamps a wind turbine blade, and a plurality of clamping base members may be movable in opposite directions or in a same direction.

The fixing barrel 330 is provided on the top of the fixing plate 214 and penetrates through the top of the fixing plate 214 and extends to the bottom of the conveying member 310, the hydraulic barrel 320 is socketed into the fixing barrel 330, and the fixing barrel 330 is in communication with the conveying member 310. The hydraulic barrel 320 inputs a hydraulic fluid to the fixing barrel 330, and the hydraulic fluid in the fixing barrel 330 is inputted to the conveying member 310, and then free movements of the clamping base members in opposite directions or in a same direction may be controlled by different transportation paths of the hydraulic fluid.

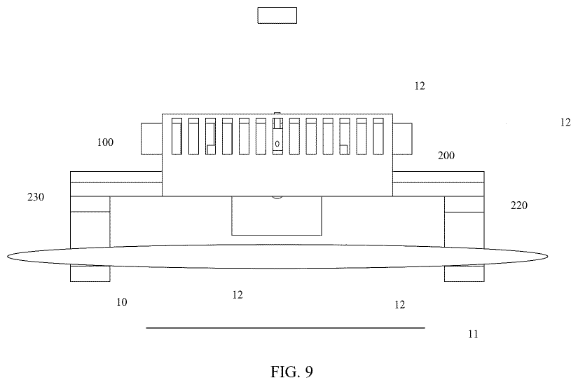

In a specific implementation process, as shown in FIG. 9, a plurality of steel cables 12 are connected between a crane base 11 and the lifting device. The lifting device clamps wind turbine blades 10 of different lengths by adjusting a distance between two clamping base members. The crane base 11 lifts the lifting device and a wind turbine blade 10 to a specified height. In order to avoid swinging during lifting, a steel cable 12 is provided to connect an end of the wind turbine blade 10 to the crane base 11. After reaching the specified height, the lifting device controls the two clamping base members to move in a same direction to a specified position so as to install the wind turbine blade 10.

The wind turbine blade lifting devices based on an offshore wind turbine unit provided in the embodiments of the present application include: a clamping assembly and an adjusting assembly, where the clamping assembly includes a clamping box and a plurality of clamping base members, the clamping box is provided with a fixing plate therein, and the plurality of clamping base members are independently provided on both sides of the clamping box; the clamping base members penetrate through a sidewall of the clamping box and extend into the clamping box, and are detachably connected to the adjusting assembly provided in the clamping box; where the clamping base members are used to clamp a wind turbine blade, and the adjusting assembly is capable of controlling free movements of the plurality of clamping base members on the clamping box in a same or in opposite directions; the adjusting assembly includes a conveying member, a hydraulic barrel, and a fixing barrel, the conveying member is provided at bottom of the fixing plate, both sides of the conveying member are detachably connected to the plurality of clamping base members, respectively; the fixing barrel penetrates through top of the fixing plate and extends to bottom of the conveying member, the hydraulic barrel is inserted into the fixing barrel, the fixing barrel is in communication with the conveying member, and free movements of the clamping base members is controlled hydraulically. When the wind turbine blade is lifted from the ground and is moved to a specified position in vertical and horizontal directions, the wind turbine blade lifting device provided by the present application can effectively avoid swaying, and at the same time, and can also effectively control an accuracy of docking, so as to improve the efficiency and safety performance of the installation of the wind turbine blade.

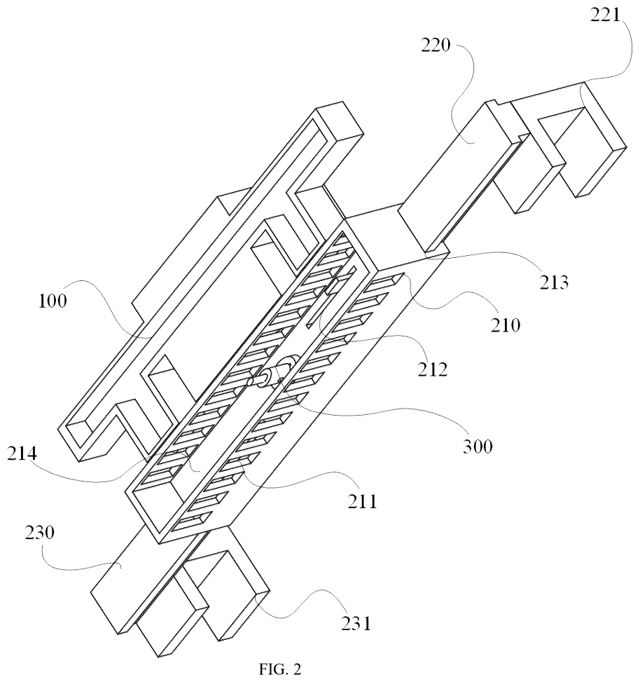

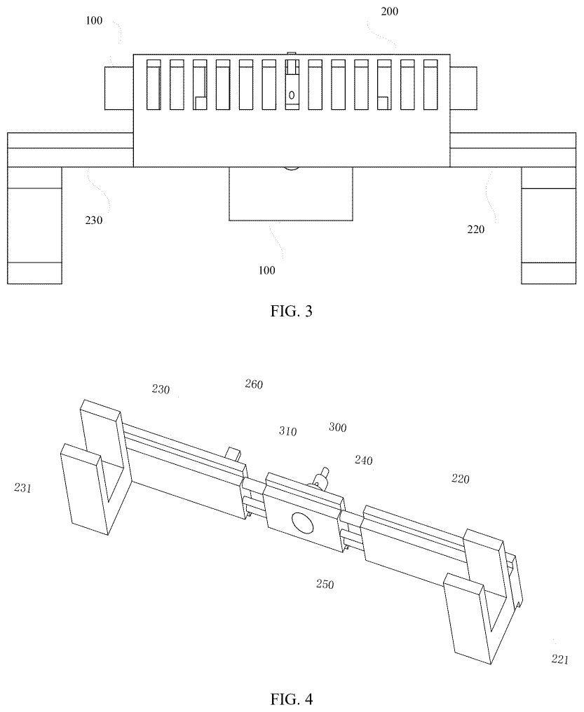

Furthermore, on the basis of the above embodiments, the clamping base members are described in more detail in following. As shown in FIG. 2 and FIG. 3, the clamping base members include a first clamping arm 220 and a second clamping arm 230, both of which have identical structure, as well as a first clamping member 221 and a second clamping member 231, both of which have identical structure. A T-slot 213 is provided on a sidewall of the clamping box 210 located below the fixing plate 214, and one end of the first clamping arm 220 penetrates through the T-slot 213 and is movably connected to and in communication with the conveying member 310, the first clamping member 221 is fixedly provided at bottom of the other end of the first clamping arm 220; the first clamping member 221 has a clamping slot parallel to the clamping box 210, and the clamping slot is used to clamp the wind turbine blade.

The first clamping arm 220 and the second clamping arm 230 are structurally identical, and penetrate through the T-slot 213 located under the fixing plate 214 from both sides of the clamping box 210, respectively, and are detachably connected with the conveying member 310 by a bolt, clamping, etc., and can slide freely in the T-slot 213. The first clamping arm 220 and the second clamping arm 230 are not only structurally identical, but also functionally cooperate with each other to ensure the stability and reliability in a process of clamping. A first clamping member 221 and a second clamping member 231 of identical structure are also connected to the first clamping arm 220 and the second clamping arm 230, respectively, by welding, bonding, etc., and the first clamping member 221 and the second clamping member 231 are both provided with a clamping slot for clamping the wind turbine blade. The clamping slot can be provided in a shape of “□” to ensure the stability and safety of the blade during a clamping process. In addition, a design of the clamping slot takes into account shape and size of the blade so as to provide optimal support and fixation during a clamping process, thereby improving the overall accuracy and efficiency of the operation.

Further, as shown in FIG. 4, a plurality of telescopic rods 240 and a plurality of hydraulic pipes 250 are provided at each side of the conveying member 310; one ends of the plurality of telescopic rods 240 are respectively independently fixedly connected to side edges of two sides of the conveying member 310, and the other ends of the plurality of telescopic rods 240 are inserted into the first clamping arm 220; the plurality of hydraulic pipes 250 are in communication with the conveying member 310 and the first clamping arm 220, and the hydraulic pipes 250 is in communication with the fixing barrel 330.

A plurality of telescopic rods 240 are provided between the conveying member 310 and the first clamping arm 220, and between the conveying member 310 and the second clamping arm 230, respectively, to ensure that the first clamping arm 220 and the second clamping arm 230 can slide freely in a direction parallel to the fixing plate 214. In addition, a plurality of hydraulic pipes 250 are provided between the conveying member 310 and the first clamping arm 220, and between the conveying member 310 and the second clamping arm 230, so that the first clamping arm 220 and the second clamping arm 230 are in communication with the conveying member 310 and the fixing barrel 330. By arranging different hydraulic fluid transportation paths in the first clamping arm 220 and the second clamping arm 230, a precise control of hydraulic fluid can be realized, so as to adjust movement directions of the first clamping arm 220 and the second clamping arm 230. Specifically, by inputting the hydraulic fluid into the first clamping arm 220 and the second clamping arm 230, the first clamping arm 220 and the second clamping arm 230 can move in a same direction or in opposite directions under control of different paths, which improves the flexibility and controllability of the system.

Furthermore, as shown in FIG. 5, a holding space is provided in the fixing barrel 330, and a plurality of connecting pipes 334 are connected to outer sidewall of the fixing barrel 330, and the connecting pipes 334 are in communication with the holding space; the connecting pipes 334 are in communication with the conveying member 310, and the hydraulic pipes 250; the hydraulic barrel 320 is socketed into the holding space, and the hydraulic barrel 320 can be moved up and down freely in the holding space.

The fixing barrel 330 is internally provided with a cylindrical holding space, and a plurality of connecting pipes 334 are connected with outer sidewall of the fixing barrel 330, and the connecting pipes 334 are in communication with the holding space, and the connecting pipes 334 are in communication with conveying member 310 and the hydraulic pipe. A hydraulic barrel 320 is socketed into the holding space, and the hydraulic barrel can slide up and down freely in the holding space, so that the hydraulic fluid inputted into the holding space is transported to the plurality of connecting pipes 334 and the conveying member 310.

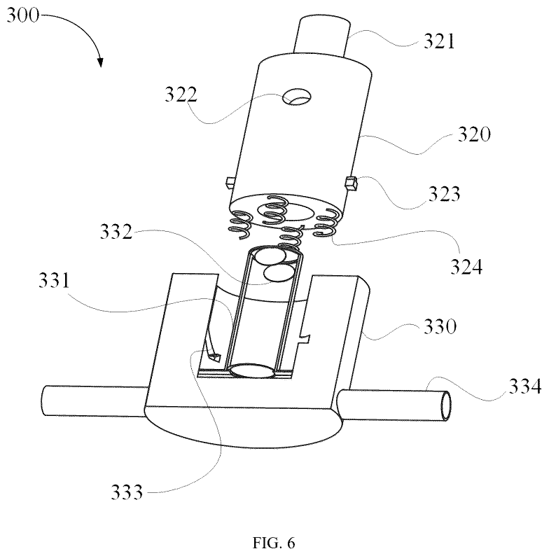

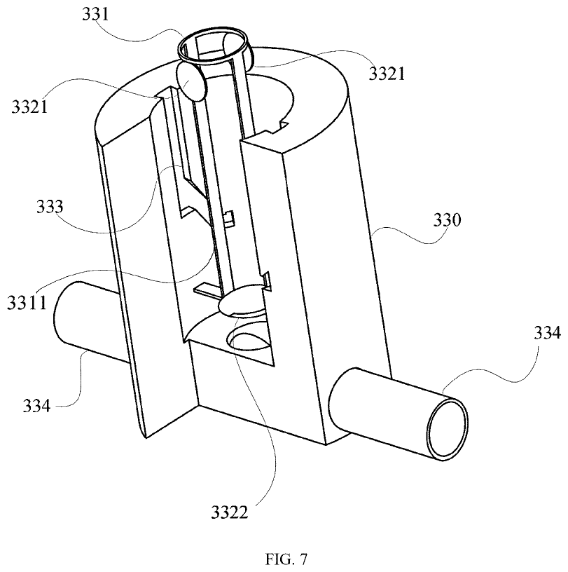

Further, as shown in FIG. 6, a blocking base member 331 is also provided in the holding space, and the blocking base member 331 is fixedly connected or detachably connected to inner sidewall of the holding space; a hydraulic orifice is provided at bottom of the hydraulic barrel 320, and when the hydraulic barrel 320 is socketed into the holding space, the blocking base member 331 is inserted into the hydraulic orifice.

A blocking base member 331 is also provided in the holding space, and the blocking base member 331 can be fixedly connected to inner sidewall of the holding space in a variety of ways, such as permanent connection ways, for example, welding, bonding, or can be detachably connected to inner sidewall of the holding space in detachable connection ways, such as a bolt, snap-fit, locking, so as to facilitate maintenance and replacement. A hydraulic orifice is provided at bottom of the hydraulic barrel 320, and when the hydraulic barrel 320 is inserted into the holding space, the blocking base member 331 is inserted into the hydraulic orifice, thereby realizing sealing and functional connection of the hydraulic system. In order to ensure that the hydraulic barrel 320 can be smoothly inserted into the holding space, size of the hydraulic barrel 320 and size of the holding space are precisely designed to be adapted to each other, which ensures the stability and reliability of the hydraulic system, and also facilitates the assembly and disassembly of the hydraulic barrel 320, improving the maintenance efficiency of the system and ease of operation. In this way, a tight connection is formed between the hydraulic barrel 320 and the holding space, which ensures that the hydraulic fluid can be effectively transferred in the system.

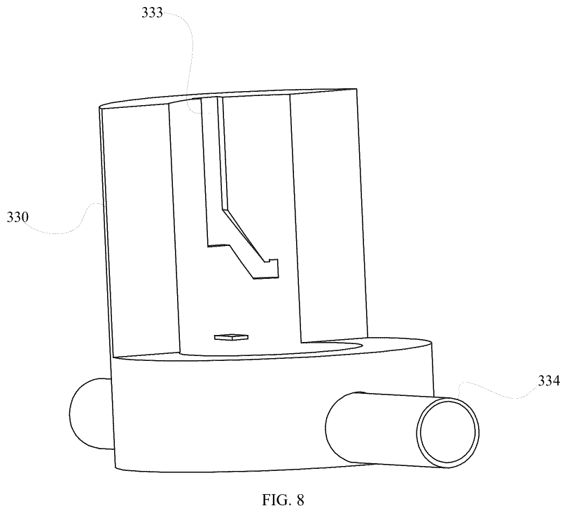

Furthermore, as shown in FIG. 6 and FIG. 8, a plurality of slide grooves 333 are provided on inner sidewall of the holding space, and a plurality of slide blocks 323 are correspondingly provided on outer sidewall of the hydraulic barrel 320; when the hydraulic barrel 320 is rotated or moved in the holding space, the slide blocks 323 slide freely in the slide grooves 333; the slide grooves 333 form a slope along the inner sidewall of the holding space such that the slide blocks 323 are temporarily stuck in the slide grooves 333 when the hydraulic barrel 320 is moved to bottom of the holding space.

A plurality of identical or different slide grooves 333 are provided on the inner sidewall of the holding space, and a design of the slide grooves 333 can be adjusted according to a specific application requirement to adapt to different operating conditions and functional requirements. Correspondingly, a plurality of slide blocks 323 are provided on the outer sidewall of the hydraulic barrel 320, and these slide blocks 323 cooperate with the slide grooves 333, so that the slide blocks 323 can slide freely along the slide grooves 333 when the hydraulic barrel 320 is rotated or moved in the holding space, thereby realizing a smooth movement and a positioning of the hydraulic barrel 320.

In a portion of the slide grooves 333 near bottom of the holding space, a slope of the slide grooves is designed so that the slide blocks 323 can be temporarily stuck in the slide grooves 333 when the hydraulic barrel 320 slides to the bottom of the holding space, to be able to ensure the stability of the hydraulic barrel 320 in a working position, and also that the hydraulic pressure or delivery path of the hydraulic fluid in the holding space can be adjusted by controlling a seating state of the slide blocks 323, to realize a precise control of the first clamping arm 220 and the second clamping arm 230, so that they can be moved in a same direction or in opposite directions. For example, when the first clamping arm 220 and the second clamping arm 230 are required to move in a same direction, the delivery path of the hydraulic fluid can be changed by adjusting a position of the hydraulic barrel 320 and thus enabling the slide blocks 323 to be snapped into place in the slide grooves 333, to ensure that the hydraulic fluid can be evenly distributed to the two clamping arms. Conversely, when the first clamping arm 220 and the second clamping arm 230 are required to move in opposite directions, a similar adjustment can be made so that the hydraulic fluid is delivered to each of the two clamping arms, thereby realizing an effect of moving in opposite directions.

Furthermore, as shown in FIG. 6, a plurality of elastic members 324 are provided at bottom of the hydraulic barrel 320; a plurality of through-holes 322 are also provided on the hydraulic barrel 320, the through-holes 322 is perpendicular to and in communication with the hydraulic orifice; a pulling member 321 is also provided at top of the hydraulic barrel 320, the pulling member 321 is used to enable the hydraulic barrel 320 to slide up and down freely in the holding space of the fixing barrel 330; a height of the hydraulic barrel 320 is greater than a depth of the holding space, and a diameter of the hydraulic barrel 320 is matched with a diameter of the holding space.

A plurality of elastic members 324 are provided at bottom of the hydraulic barrel 320, which are designed to provide additional cushioning and stability to ensure that the hydraulic barrel 320 can effectively absorb vibrations and shocks during a working process; and at the same time, when the hydraulic barrel 320 is moved to bottom of the fixing barrel 310, a upward elastic force of the elastic members 324 makes the slide blocks 323 more securely stuck in the slide grooves 333; when it is intended to move the hydraulic barrel 320 upward, the elastic members 324 provide an elastic force so that the hydraulic barrel can move upward more quickly. The hydraulic barrel 320 is also provided with a plurality of through-holes 322, which are perpendicular to and in communication with the hydraulic orifice, thereby ensuring that the hydraulic fluid can flow freely between inside and outside of the hydraulic barrel 320, realizing efficient operation of the hydraulic system.

Top of the hydraulic barrel 320 is also provided with a pulling member 321, which is designed to facilitate an operator to easily pull the hydraulic barrel 320 when needed to enable the hydraulic barrel 320 to slide up and down freely in the holding space of the fixing barrel 330. The provision of the pulling member 321 improves the ease of operation of the hydraulic barrel 320 and also enhances its flexibility during maintenance and replacement. The bottom of the fixing barrel 330 is provided with an orifice, which is in communication with the orifice provided on the connecting pipes 334, forming a complete hydraulic fluid transmission path. When the hydraulic fluid is input to the fixing barrel 330, the hydraulic fluid can be efficiently conveyed to various parts of the system through the orifice and the connecting pipes 334, thereby realizing a precise control of the first clamping arm 220 and the second clamping arm 230. By delivering the hydraulic fluid, movement directions of the first clamping arm 220 and the second clamping arm 230 can be controlled separately so that they can move in a same direction or in opposite directions according to a specific requirement.

Further, as shown in FIG. 7, the blocking base member 331 includes a plurality of blocking plates 332 and a blocking plate frame 3311; the blocking plate frame 3311 is connected to inner wall of the holding space, and a plurality of circular plates 3321 are provided at top of the blocking plate frame 3311, and sizes of the circular plates 3321 are matched with the through-holes 322; a circular convex plate 3322 is provided at bottom of the blocking plate frame 3311, and a size of the circular convex plate 3322 is matched with the hydraulic orifice; when the hydraulic barrel 320 is moved upwardly in the holding space, the blocking plates 332 are enabled to block the through-holes 322, to adjust the first clamping arm 220 and the second clamping arm 230 to move in opposite directions; and when the hydraulic barrel 320 is moved downwardly in the holding space, the circular convex plate 3322 is enabled to block the hydraulic orifice, to adjust the first clamping arm 220 and the second clamping arm 230 to move in a same direction.

The plurality of blocking plates 332 on the blocking base member 331 are connected via the blocking plate frame 3311, the blocking plate frame 3311 is fixedly connected to inner wall of the holding space. Top of the blocking plate frame 3311 is provided with a plurality of circular plates 3321, the plurality of circular plates 3321 are precisely designed in size to match the through-holes 322 on the hydraulic barrel 320 to ensure that the through-holes 322 can be effectively blocked under certain conditions. Bottom of the blocking plate frame 3311 is provided with a circular convex plate 3322, and the circular convex plate 3322 is also precisely designed in size to match the hydraulic orifice to ensure that the hydraulic orifice can be effectively blocked when required.

As the hydraulic barrel 320 moves upwardly in the holding space, the blocking plates 332 will gradually approach and eventually block the through-holes 322 to change a flow path of the hydraulic fluid, thereby adjusting an opposite movement between the first clamping arm 220 and the second clamping arm 230. Specifically, when the through-holes 322 are blocked by the blocking plates 332, hydraulic fluid will be forced to flow through other predetermined path, thereby realizing a control of the above two clamping arms in opposite directions, which can accurately control a direction of movement of the clamping arms, and also can quickly adjust a working state of a system to adapt to different operational requirements when needed.

On the contrary, when the hydraulic barrel 320 moves downwardly in the holding space, the circular convex plate 3322 will gradually approach and eventually block the hydraulic orifice, the flow path of the hydraulic fluid will also thus be changed, thereby adjusting a same direction movement between the first clamping arm 220 and the second clamping arm 230. When the hydraulic orifice is blocked by the circular convex plate 3322, the hydraulic fluid will flow through another predetermined path, thereby realizing a same direction control between the two clamping arms, which can ensure efficient operation of the system, and can also provide flexible operation options under different working conditions.

Furthermore, as shown in FIG. 2, top of the first clamping arm 220 is fixedly provided with a sliding member 260, and correspondingly, the fixing plate 214 is provided with a bar slot 212; the sliding member 260 is clamped in the bar slot 212, and the sliding member 260 freely slides in the bar slot 212 when the first clamping arm 220 is freely moved; a maximum or minimum movement distance of the first clamping arm 220 is controlled by the sliding member 260 and the bar slot 212.

In order to ensure that the first clamping arm 220 and the second clamping arm 230 can be effectively controlled when they freely slide in the clamping box 210, and to avoid that their movement distances are too large which may result in an excessive force on the system or a damage to the lifting device, a precise sliding control mechanism is designed. Each of the first clamping arm 220 and the second clamping arm 230 is fixedly provided with a sliding member 260 at tops thereof, and the sliding member 260 is designed to provide additional stability and control so that the clamping arms can be kept smooth and controlled during movement. Correspondingly, a bar slot 212 is provided on the fixing plate 214, and length and position of the bar slot 212 are designed to ensure that a sufficient sliding range can be provided while limiting the maximum and minimum movement distances of the clamping arms. The sliding member 260 is clamped in the bar slot 212, and the sliding member 260 can slide freely in the bar slot 212 when the first clamping arm 220 and the second clamping arm 230 move freely in the clamping box 210, thereby realizing a precise control of movement distances of the clamping arms. A highly integrated sliding control system is formed between the sliding member 260 and the bar slot 212. When the first clamping arm 220 and the second clamping arm 230 move in the clamping box 210, the sliding member 260 slides in the bar slot 212, thereby limiting the maximum and minimum movement distances of the clamping arms, preventing the clamping arms from moving too far and thus resulting in an excessive force on the lifting device, and ensuring that the clamping arms are always kept in a safe and controlled range during a working process, thereby improving the overall stability and reliability of the lifting device.

Furthermore, as shown in FIG. 1 and FIG. 3, the wind turbine blade lifting device further includes a control platform 100, the control platform 100 is connected to snap-fit slots 211 on outside of the clamping box 210 and is in communication with the adjusting assembly 300; the clamping base members are controlled to move freely by inputting the hydraulic fluid into the adjusting assembly 300 via the control platform 100; the control platform 100 includes a connecting arm 110 and an transporting pipe 120, the connecting arm is connected to the clamping box 210, and the transporting pipe 120 penetrates through the clamping box 210 and is in communication with the adjusting assembly 300.

The control platform 100 of the wind turbine blade lifting device is connected to outside of the clamping box 210 and is in communication with the adjusting assembly 300. Free movements and precise control of the clamping base members are achieved by inputting the hydraulic fluid into the adjusting assembly 300 via the control platform 100. The control platform 100 provides a convenient and efficient operating interface that enables an operator to easily adjust various parameters of the lifting device, thereby ensuring the stability and reliability of the wind turbine blade lifting device.

The connecting arm 110 in the control platform 100 is firmly connected to the clamping box 210, which provides a stable support structure that allows the control platform 100 to be securely fixed in the system. The connecting arm 110 has a certain degree of strength and stability, and also takes into account ease of installation and maintenance.

The transporting pipe 120 in the control platform 100 penetrates through the clamping box 210 and is in communication with the adjusting assembly 300 to form a complete hydraulic fluid transportation path. Through the transporting pipe 120, the hydraulic fluid can be smoothly transported from the control platform 100 to the adjusting assembly 300, thereby realizing a precise control of the system. The transporting pipe 120 usually selects materials with high strength, corrosion resistance and high pressure resistance properties to ensure a long-term operation in complex working environments.

In an actual operation, the control platform 100, by cooperation of the connecting arm 110 and the transporting pipe 120, allows an operator to easily input the hydraulic fluid into the adjusting assembly 300, thereby controlling free movements of the clamping base members and enhancing the operability of the lifting device. An operator can precisely adjust positions and angles of the clamping base members using the control platform 100, thereby ensuring the stability and safety of the wind turbine blade.

It should be noted that, for the above method embodiments, they are all expressed as a series of action combinations for the sake of simple description, but the person skilled in the art should be aware that the present application is not limited by the order of the described actions, because that according to the present application, some of the steps may be carried out in other sequences or at the same time. Additionally, the person skilled in the art should also be aware that the embodiments described in the specification are feasible embodiments, and the actions and modules involved are not necessarily required for the present application.

The embodiments or implementations in the present specification are described in a progressive manner, and each embodiment focuses on the difference from other embodiments, and the same and similar parts of the embodiments can refer to each other.

It should be noted that the phrases such as “in a specific implementation”, “in some embodiments”, “in the present embodiment”, “exemplarily” described in the present specification indicate that the described embodiments may include a particular feature, structure, or characteristic, but it is not necessary for every embodiment includes the particular feature, structure, or characteristic. Furthermore, such phrases may not necessarily refer to the same embodiment. Furthermore, in describing a particular feature, structure, or characteristic in conjunction with an embodiment, the realization of such a feature, structure, or characteristic in conjunction with other embodiment, explicitly or not explicitly described, is within the scope of knowledge of those skilled in the art.

In general, terms should be understood, at least partially, by their use in context. For example, at least partially according to context, the term “one or more” as used in the text may be used to describe any feature, structure or characteristic in singular sense, or may be used to describe a combination of features, structures or characteristics in plural sense. Similarly, depending at least partially on the context, terms such as “a” or “the” may also be understood as conveying singular usage or plural usage.

It should be easily understood that the terms “on . . . ”, “above . . . ” and “on top of . . . ” in the present disclosure should be interpreted in the widest way, so that the terms mean not only “directly on something” but also includes the meaning of “on something” with an intermediate feature or layers in between, and “above . . . ” or “on top of . . . ” not only includes the meaning of “above something” or “on top of”, but also includes the meaning of “above something” or “on top of” without intermediate feature or layer in between (i.e., directly on something).

In addition, for convenience of explanation, spatial relative terms such as “under”, “below”, “lower”, “above”, “upper” herein can be used to describe the relationship of one element or feature relative to other element or feature, as shown in the figures. The spatial relative term is intended to encompass different orientations of devices in use or operation, in addition to the orientations shown in the accompanying drawings. The device can have other orientations (rotated by 90 degrees or in other orientations), and the spatial relative descriptors used herein can also be interpreted correspondingly. In the above embodiments, the description of each embodiment has its own emphasis, and the contents that are not detailed in one embodiment may refer to the relevant descriptions of other embodiments. The technical features of the above embodiments can be combined in any way. In order to make the description concise, not all possible combinations of the various technical features in the above embodiments have been described. However, as long as there is no contradiction in the combination of these technical features, they should be considered within the scope of the present specification.

Further, in the description of the present application, it is also to be noted that the terms “before”, “after” and the like indicate an orientation or positional relationship based on an orientation or positional relationship, or an orientation or positional relationship in which the product of the invention is customarily placed in use, and are used only for the purpose of facilitating the description of the present application and simplifying the description, and do not indicate or imply that the mentioned device or element must have a particular orientation or be constructed and operated in a particular orientation. Therefore they cannot be construed as a limitation of the present application. Furthermore, the terms “first”, “second”, etc. are used only to distinguish descriptions and are not to be understood as indicating or implying relative importance.

Other embodiments of the present application will readily come to mind to those skilled in the art upon consideration of the specification and practice of the invention disclosed herein. The present application is intended to cover any variations, uses, or adaptations of the present application, and these variations, uses, or adaptations follow the general principles of this application and include common knowledge or conventional technical means in the art not disclosed herein. The specification and embodiments are to be regarded as exemplary only, and the true scope and spirit of the present application are indicated in the following claims.

It should be understood that the present application is not limited to a precise structure which has been described above and illustrated in the accompanying drawings, and that various modifications and changes may be made without departing from the scope of the present application. The scope of the present application is limited only by the appended claims.

What is claimed is:

1. A wind turbine blade lifting device based on an offshore wind turbine system, comprising:
a clamping assembly and an adjusting assembly;
wherein the clamping assembly comprises a clamping box and a plurality of clamping base members, the clamping box is internally provided with a fixing plate, and the plurality of clamping base members are independently provided on both sides of the clamping box; the clamping base members penetrate through a sidewall of the clamping box and extend into the clamping box, and are detachably connected to the adjusting assembly provided in the clamping box;
wherein the clamping base members are configured to clamp a wind turbine blade, and the adjusting assembly is capable of controlling free movements of the plurality of clamping base members on the clamping box in a same direction or in opposite directions;
wherein the adjusting assembly comprises a conveying member, a hydraulic barrel and a fixing barrel, the conveying member is provided at bottom of the fixing plate, both sides of the conveying member are respectively detachably connected to the plurality of clamping base members; and
wherein the fixing barrel penetrates through top of the fixing plate and extends to bottom of the conveying member, the hydraulic barrel is socketed into the fixing barrel, the fixing barrel is in communication with the conveying member, and free movements of the clamping base members are controlled hydraulically.

2. The wind turbine blade lifting device according to claim 1, wherein the clamping base members comprise a first clamping arm and a second clamping arm of identical structure, as well as a first clamping member and a second clamping member of identical structure;
wherein a T-slot is provided on a sidewall of the clamping box located below the fixing plate, and an end of the first clamping arm penetrates through the T-slot and is movably connected to and in communication with the conveying member; and the first clamping member is fixedly provided at bottom of the other end of the first clamping arm; and
wherein the first clamping member has a clamping slot parallel to the clamping box, and the clamping slot is configured to clamp the wind turbine blade.

3. The wind turbine blade lifting device according to claim 2, wherein a plurality of telescopic rods, and a plurality of hydraulic pipes are provided at each side of the conveying member;
one ends of the plurality of telescopic rods are independently fixedly connected to side edges of two sides of the conveying member, respectively, and the other ends of the plurality of telescopic rods are socketed into the first clamping arm; and
the plurality of hydraulic pipes communicate the conveying member with the first clamping arm, and the hydraulic pipes is in communication with the fixing barrel.

4. The wind turbine blade lifting device according to claim 3, wherein a holding space is provided in the fixing barrel, and a plurality of connecting pipes are connected to an outer sidewall of the fixing barrel, and the connecting pipes are in communication with the holding space; and
the connecting pipes are in communication with the conveying member, and the hydraulic pipes; the hydraulic barrel is socketed into the holding space, and the hydraulic barrel moves up and down freely in the holding space.

5. The wind turbine blade lifting device according to claim 4, wherein a blocking base member is further provided in the holding space, and the blocking base member is fixedly connected or detachably connected to an inner sidewall of the holding space; and
a hydraulic orifice is provided at bottom of the hydraulic barrel, and when the hydraulic barrel is socketed into the holding space, the blocking base member is inserted into the hydraulic orifice.

6. The wind turbine blade lifting device according to claim 5, wherein a plurality of slide grooves are provided on the inner sidewall of the holding space, and a plurality of slide blocks are correspondingly provided on an outer sidewall of the hydraulic barrel; and
when the hydraulic barrel is rotated or moved in the holding space, the slide blocks slide freely in the slide grooves; and the slide grooves form a slope along the inner sidewall of the holding space so that the slide blocks are temporarily stuck in the slide grooves when the hydraulic barrel is moved to bottom of the holding space.

7. The wind turbine blade lifting device according to claim 6, wherein a plurality of elastic members are provided at the bottom of the hydraulic barrel;
a plurality of through-holes are further provided on the hydraulic barrel, and the through-holes are perpendicular to and in communication with the hydraulic orifice;
a pulling member is further provided at top of the hydraulic barrel, the pulling member is configured to enable the hydraulic barrel to slide up and down freely in the holding space of the fixing barrel; and
a height of the hydraulic barrel is greater than a depth of the holding space, and a diameter of the hydraulic barrel is matched with a diameter of the holding space.

8. The wind turbine blade lifting device according to claim 7, wherein the blocking base member comprises a plurality of blocking plates and a blocking plate frame;
the blocking plate frame is connected to an inner wall of the holding space, and a plurality of circular plates are provided at top of the blocking plate frame, and sizes of the circular plates are matched with the through-holes; a circular convex plate is provided at bottom of the blocking plate frame, and a size of the circular convex plate is matched with the hydraulic orifice;
when the hydraulic barrel is moved upwardly in the holding space, the blocking plates are enabled to block the through-holes, to adjust the first clamping arm and the second clamping arm to move in opposite directions; and
when the hydraulic barrel is moved downwardly in the holding space, the circular convex plate is enabled to block the hydraulic orifice, to adjust the first clamping arm and the second clamping arm to move in a same direction.

9. The wind turbine blade lifting device according to claim 2, wherein top of the first clamping arm is fixedly provided with a sliding member, and correspondingly, the fixing plate is provided with a bar slot;
the sliding member is stuck in the bar slot, and the sliding member freely slides in the bar slot when the first clamping arm is freely moved; a maximum or minimum movement distance of the first clamping arm is controlled by the sliding member and the bar slot.

10. The wind turbine blade lifting device according to claim 1, wherein the wind turbine blade lifting device further comprises a control platform, the control platform is connected to outside of the clamping box and is in communication with the adjusting assembly; the clamping base members are controlled to move freely by inputting a hydraulic fluid into the adjusting assembly via the control platform;
wherein the control platform comprises a connecting arm and an transporting pipe, the connecting arm is connected to the clamping box, and the transporting pipe penetrates through the clamping box and is in communication with the adjusting assembly.
